(19) United States
(12) Patent Application Publication
(10) Pub. No.: US 2010/0156933 A1
(43) Pub. Date: Jun. 24, 2010

(54) VIRTUALIZED REAL WORLD ADVERTISING SYSTEM

(75) Inventors: M. Cameron Jones, San Jose, CA (US); Elizabeth F. Churchill, San Francisco, CA (US); Athellina Athsani, San Jose, CA (US)

Correspondence Address: BRINKS HOFER GILSON & LIONE / YAHOO! OVERTURE, P.O. BOX 10395, CHICAGO, IL, 60610, US

(73) Assignee: Yahoo! Inc., Sunnyvale, CA (US)

(21) Appl. No.: 12/340,524

(22) Filed: Dec. 19, 2008

(51) Int. Cl. G06Q 30/00; G06Q 40/00; G06F 17/30; G09G 5/00

(52) U.S. Cl. 345/629; 705/37; 705/31; 705/14.49

(57) ABSTRACT

An advertising system associates advertisements with virtualized real-estate on a map image. Virtualized real-estate includes locations on a map image that correspond to real world locations associated with a user, such as a home, business, or other location. The system matches a user's virtualized real-estate with advertisements based on user preferences, advertiser preferences, and tracking information. The system also allows users to auction off virtualized real-estate to advertisers. Thereafter, advertisements matched with virtualized real-estate are overlaid on the virtualized real-estate in the map image.

### BACKGROUND

1. Technical Field

The present description relates generally to on-line advertising and, more particularly, but not exclusively, to on-line advertising on virtualized real-estate.

2. Related Art

The availability of powerful tools for developing and distributing Internet content has led to an increase in information, products, and services offered through the Internet, as well as a dramatic growth in the number and types of consumers using the Internet. With this increased consumer traffic, the number of advertisers promoting their goods and services through the Internet has also grown dramatically.

Advertisers may pay publishers to host or sponsor their advertisements on Web pages, search engines, browsers, or other online media. Advertising on map images, in particular, may provide an important source of revenue for e-commerce enterprises, such as Internet based search engines, advertisers, etc. Users often access and query on-line mapping enterprises based on an interest in a particular location or region. In this regard, advertising associated with the mapping services may provide contextually and geographically relevant advertising information to the user.

For example, a user may conduct an on-line search for an address associated with a pizza shop in a particular area. In response thereto, a map showing the location of the pizza shop may be displayed to the user. Advertisements may be displayed on or around the map image for advertisers having other pizza or food establishments, or other related businesses, located near the location queried by the user.

Often, however, advertisements are displayed in areas that users do not notice or have grown accustomed to ignoring, such as on banner advertisement or at the periphery of the viewable area. Further, relevant advertisements are not always displayed even though the advertiser's business is relevant to the user's interests/needs or located near the location queried by the user. A user may therefore be presented with irrelevant or useless advertisements while relevant and useful advertisements fail to be displayed, or may be displayed in locations that the user will not notice. Accordingly, there is a need for a system and method for more effectively identifying and placing relevant and useful advertisements or other information/content for presentation to a user.

### BRIEF SUMMARY

A system is disclosed for associating advertisements with virtualized real-estate on a map image. Virtualized real-estate includes locations on a map image that correspond to real world locations associated with a user, such as a home, business, or other location. The system matches a user's virtualized real-estate with advertisements based on user preferences, advertiser preferences, and tracking information. The system also allows users to auction off virtualized real-estate to advertisers. Thereafter, advertisements matched with virtualized real-estate are overlaid on the virtualized real-estate in the map image.

Other systems, methods, features, and advantages will be, or will become, apparent to one with skill in the art upon examination of the following figures and detailed description. It is intended that all such additional systems, methods, features, and advantages be included within this description, be within the scope of the invention, and be protected by the following claims.

### BRIEF DESCRIPTION OF THE DRAWINGS

Non-limiting and non-exhaustive descriptions are provided with reference to the following figures. The components in the figures are not necessarily to scale, with an emphasis instead being placed upon illustrating the principles of the invention. Moreover, in the figures, like-referenced numerals designate corresponding parts throughout the different views.

FIG. 1 shows a general architecture of a system for virtualized real world advertising.

FIG. 2 shows the virtualized real world advertising system of FIG. 1 including a user registration program, an advertiser networking program, a control program, and a tracking program.

FIG. 3 shows an exemplary process that may be used to associate advertisements with virtualized real-estate.

FIG. 4 shows a map image rendition including an advertisement overlaid on virtualized real-estate.

FIG. 5 shows a zoomed-out rendition of the map location shown in FIG. 4.

FIG. 6 shows a map image rendition including a user-generated content annotation.

FIG. 7 shows a street-level first-person image including an advertisement overlaid on a structure shown in the image.

FIG. 8 shows a street-level first person image including a directional/distance identifier overlaid on the image.

FIG. 9 shows a map image rendition showing identified whitespace regions surrounding an airport region.

### DETAILED DESCRIPTION

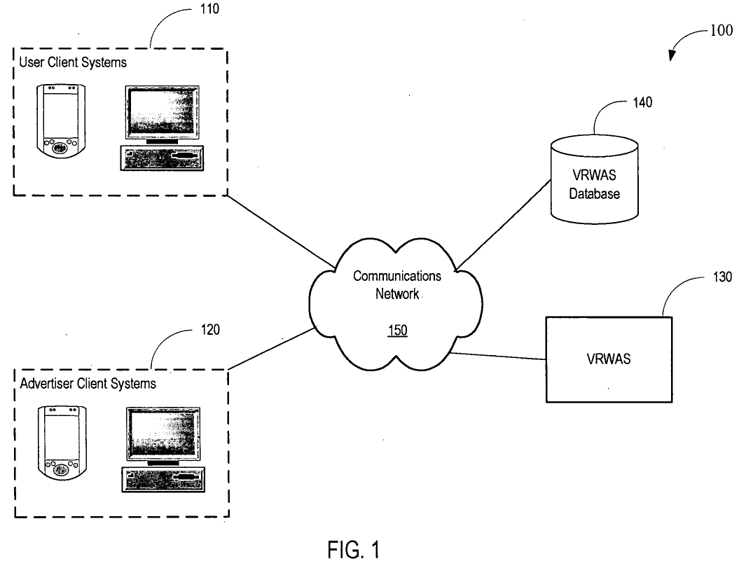

FIG. 1 shows a general architecture 100 of a system for virtualized real world advertising. The architecture 100 may include user client systems 110, advertiser client systems 120, a virtualized real world advertising system (“VRWAS”) 130, and a virtualized real world advertising system database (“VRWAS database”) 140.

The VRWAS 130 provides a user interface that allows the user client system 110 to monetize on virtualized real-estate. Virtualized real-estate may include locations on a map image, such as 2D map space in Map view, Satellite/Ariel View, Terrain View, Longitude, Latitude, a street-level first-person image, rich-media annotations of virtualized real world geolocations, or other location based rendition/permutations of real world geographic locations, that correspond to real world locations associated with a user, such as a home, business, or other property. Virtualized real-estate may also include user generated content (“UGC”) or system generated content on dynamic map interfaces, such as map annotations, info bubbles, routes, or other information that may be appended to a map image.

The VRWAS 130 may provide an advertiser interface that allows the advertiser client systems to purchase virtualized real-estate on or around which to place their advertisements. The VRWAS 130 may be provided or otherwise hosted by a publisher or other entity for hosting on-line content, such as the map image on which the virtualized real-estate is located, as well as the advertising content to be published.

The VRWAS 130 may obtain from the user client system 110 an identification of the user's virtualized real-estate, including user preferences related to how, where, and what advertisements will be placed thereto. The VRWAS 130 may obtain from the advertiser client systems 120 an identification of the advertisements to be published, as well as advertiser preferences related to how, where, and on what virtualized real-estate the advertiser wishes its advertisements to be placed. The information obtained from the user client systems 110 and advertiser client systems 120 in regards to the virtualized real-estate and advertisements, respectively, may be stored in the VRWAS database 140.

The VRWAS 130 may provide a bidding model which allows the users, through the user client system 110 to place the virtualized real-estate up for bid, and allows advertisers, through the advertiser client systems 120, to bid on the virtualized real-estate. The VRWAS 130 may apply matching algorithms/rules that automatically match, based on the user preferences and/or advertiser preferences, advertisements with virtualized real-estate. The algorithms/rules may be stored in the VRWAS database 140. The advertisements and virtualized real-estate are matched to ensure that viewers of a map image on which advertisements are placed are provided with geographically and/or contextually relevant advertisements. The VRWAS 130 applies the matching advertisements to the virtualized real-estate.

The user and/or advertiser interfaces may be accessed by the user and advertiser client systems, respectively, through a communications network 150. The communications network 150 may be any private or public communications network or combination of networks. The communications network 150 may be configured to couple one computing device, such as a server, system, database, or other network enabled device, to another device, enabling communication of data between the devices. The communications network 150 may generally be enabled to employ any form of computer-readable media for communicating information from one computing device to another. The communications network 150 may include one or more of a wireless network, a wired network, a local area network (LAN), a wide area network (WAN), a direct connection, such as through a Universal Serial Bus (USB) port, and may include the set of interconnected networks that make up the Internet. The communications network 150 may implement any communication method by which information may travel between computing devices.

The user client system 110 and advertiser client system 120 may connect to the VRWAS 130 via the Internet using a standard browser application. A browser-based implementation allows system features to be accessible, regardless of the underlying platform of the client systems 110 and 120. The client systems 110 and 120 may be a desktop, laptop, handheld computer, cell phone, mobile messaging device, network enabled television, digital video recorder, such as TIVO, automobile, or other network enabled client systems 110 and 120, which may use a variety of hardware and/or software packages. The client systems 110 and 120 may connect to the VRWAS 130 using a stand-alone application (e.g., a browser via the Internet, a mobile device via a wireless network, or other applications) which may be platform-dependent or platform-independent. Other methods may be used to implement the client systems 110 and 120.

The components of the architecture 100 may be separate, may be supported on a single server or other network enabled system, or may be supported by any combination of servers or network enabled systems. The components of the architecture 100 may include, or access via the communications network 150, one or more databases for storing data, variables, parameters, statistics, programs, Web pages, search listings, advertising content, map renditions, or other information related to advertisement publishing, mapping, or other systems.

Although selected aspects, features, or components of the implementations are described as being stored in memories, all or part of the systems, including the methods and/or instructions for performing such methods consistent with the VRWAS 130, may be stored on, distributed across, or read from other computer-readable media, for example, secondary storage devices such as hard disks, floppy disks, and CD-ROMs; a signal received from a network; or other forms of ROM or RAM either currently known or later developed.

A “computer-readable medium,” “machine-readable medium,” “propagated-signal” medium, and/or “signal-bearing medium” may comprise any means that contains, stores, communicates, propagates, or transports software for use by or in connection with an instruction executable system, apparatus, or device. The computer-readable medium may selectively be, but is not limited to, an electronic, magnetic, optical, electromagnetic, infrared, or semiconductor system, apparatus, device, or propagation medium. A non-exhaustive list of examples of a machine-readable medium may include: an electrical connection “electronic” having one or more wires, a portable magnetic or optical disk, a volatile memory such as a Random Access Memory “RAM” (electronic), a Read-Only Memory “ROM” (electronic), an Erasable Programmable Read-Only Memory (EPROM or Flash memory) (electronic), or an optical fiber (optical). A computer-readable medium may also include a tangible medium upon which software is printed, as the software may be electronically stored as an image or in another format (e.g., through an optical scan), then compiled, and/or interpreted, or otherwise processed. The processed medium may then be stored in a computer and/or machine memory.

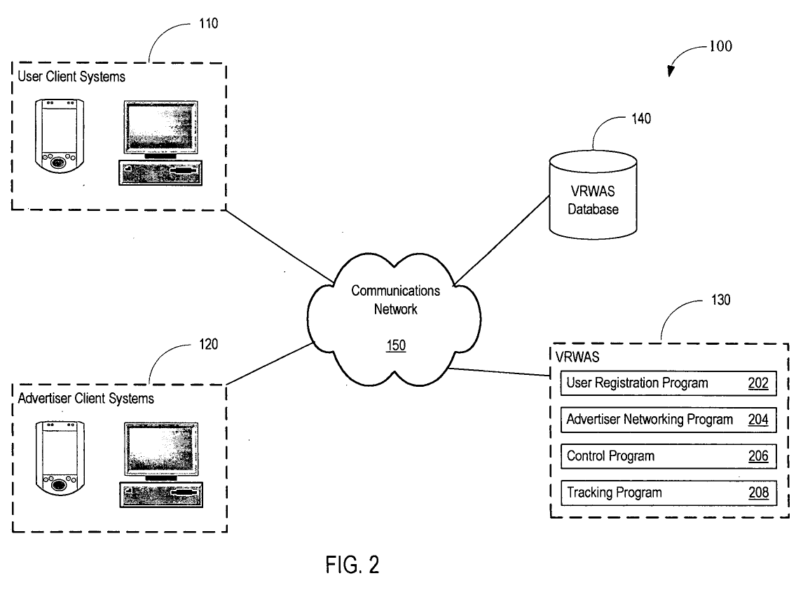

FIG. 2 shows the VRWAS 130 of FIG. 1 including a user registration program 202, an advertiser networking program 204, a control program 206, and a tracking program 208. Each of the user registration program 202, advertiser networking program 204, control program 206, and tracking program 208 may include or otherwise be associated with a database or other memory cluster for storing information associated with each.

Specific components 202-208 of the VRWAS 130 may include additional or different components. One or more processors may be implemented as a microprocessor, microcontroller, application specific integrated circuit (ASIC), discrete logic, or a combination of other types of circuits or logic. Similarly, memories may be DRAM, SRAM, Flash, or any other type of memory. Parameters, (e.g., user preferences), databases, and other data structures may be separately stored and managed, may be incorporated into a single memory or database, or may be logically and physically organized in many different ways. Programs or instruction sets may be parts of a single program, separate programs, or distributed across several memories and processors.

The user registration program 202 may be in communication with (such as through the communications network 150, a direct connection, or other communication methods) the user client system 110 to obtain user information associated with and identifying virtualized real-estate. Virtualized real-estate may include locations on a map image, such as on an on-line map, a street-level first-person image, or other location based rendition/permutations of real world geographic locations, that correspond to real world locations associated with a user, such as a home, business, or other property. Virtualized real-estate may also include geographic location-based UGC, such as on user generated map annotations to a map image. A user may be an individual, business, community, or other entity.

The obtained user information may also include user preferences related to how, where and what ads are to be displayed on or otherwise associated with the user's virtualized real-estate. The user registration program 202 may be configured to provide a variety of ad placement models from which the user can choose. The user registration program 202 may provide a registration model that allows the user to register the user's virtualized real-estate into the VRWAS 130. After registration, the control program 206 may, as discussed below, automatically place ads on, or otherwise associate ads with, the virtualized real-estate. The automatic placement of the ads onto the registered virtualized real-estate may be based on a variety of factors, including user preferences, advertiser preferences, and/or tracking information collected by the tracking program 208.

As noted, the automatic placement of ads may be based, at least in part, on user preferences. The user registration program 202 may be configured to allow a user to input preferences related to how, where and what ads the control program 206 may associate with the user's virtualized real-estate. Taking the user preferences into consideration, the control program 206 automatically places ads on the user's virtualized real-estate. The user preferences may include certain types of content that the user does or does not wish to be associated with the virtualized real-estate. For example, the user registration program 202 may allow a user to indicate a preference that ads related to tobacco products not be placed on the user's virtualized real-estate. In this example, during automatic placement of ads on the user's virtualized real-estate, the control program 206 may consider only non tobacco-product related ads.

The user registration program 202 may provide a user interface that allows the user to register the user's virtualized real-estate. Information requested from the user through the interface may include an identification of the user, the identification of the virtualized-real estate, user preferences, and any other relevant information for the identification of the virtualized real-estate. An identification of the virtualized real-estate may be provided by an address, longitude/latitude coordinates, geo-code data, or other data allowing the VRWAS 130 to identify and locate the virtualized real-estate on a map image. The user interface may include a list, such as a clickable list or menu, of preferences from which to select. The user interface may allow the user to select advertisers or types of advertisers or products from which a user can select exclusions. The user interface may also be configured to allow a user to select preferences such that during the automatic ad placement, certain user preferred advertising content or advertisers may be weighted higher and thus be more likely to be placed on the user's virtualized real-estate.

Through an advertiser interface provided by the advertiser networking program 204, advertisers may register or otherwise submit ads they wish to be placed on virtualized real-estate. The advertiser interface may also obtain advertiser preferences related to how, what, or where the ads are placed on virtualized real-estate. The control program 206, considering user and advertiser preferences, may automatically place ads on the registered virtualized real-estate. For example, the advertiser preferences may also include preferences and/or exclusions corresponding to the type of virtualized real-estate on which its ads are placed. An advertiser may wish that its ads are placed on a map within one mile of sports arenas, or may wish that its ads be placed within a certain distance from the map locations corresponding to the advertiser's brick and mortal (“B&M”) locations. The control program 206 considers the user and advertiser preferences to match the ads with the registered virtualized real-estate.

The user registration program 202 may also provide a bid model that allows a user to place their virtualized real-estate up for bid. The bid model may afford the user a level of autonomy on how, where and what advertisements will be displayed on their virtualized real-estate. The bid model, which may also be provided through a user interface, may allow the user to choose to have random ads displayed, ads of a certain type of subject matter, or ads the control program 206 chooses based on tracking information obtained by the tracking program 208.

For example, the user registration program 202 may allow a community to auction off the virtualized real-estate associated with their neighborhood. An individual user may auction off the virtualized real-estate corresponding to their home to have ads placed on the on-line map location corresponding to the real world location of the home. A business may auction off the virtualized real-estate corresponding to their office site.

Through the advertiser interface provided by the advertiser networking program 204, advertisers may view a list of and bid for the right to place their ads on particular virtualized real-estate placed up for auction by the users. The advertiser interface may also be configured to allow advertisers to search for virtualized real-estate on which to bid based on types and characteristics of the virtualized real-estate.

The advertiser interface may allow the advertiser to search for and bid on ad space for virtualized real-estate based on a variety of configurable factors including map view types (such as zoom in, zoom out), keywords/tags on map annotations, specific locations, or other criteria. For example, the advertiser may bid to have its ad overlaid on each lamppost identified on a street-level first-person image or rich-media augmentation. A shoe company, for example, may bid to place ads on virtualized real-estate viewed on mobile devices of users identified by the tracking program 208 as frequently being on the move. The advertiser interface may be configured to allow the advertiser to bid on different map resolutions, that is, to place ads on certain virtualized real-estate only at certain map resolutions based on how far zoomed-in/zoomed-out the map is. The advertiser may search for and bid on specific locations, such as to have its ad placed on a certain virtualized real-estate under all conditions. For example, if a company finds that there is virtualized real-estate up for bid whose B&M location is nearby the B&M location of the advertiser's facilities, the advertiser may bid to have its ad placed on that specific virtualized real-estate for any resolution or other map-view condition.

Advertiser may also bid to place ads on specific virtualized real-estate under specific conditions, such as the previously mentioned map resolution conditions, and also based on user data obtained by the tracking program 208, based on historical user traffic data, and other criteria. The advertiser interface may be configured to allow the advertiser to bid, not just on specific locations, but also on specific user criteria. For example, the advertiser may bid to have its ads placed on virtualized real-estate near sports arenas, or on virtualized real-estate viewed on mobile phones, or based on other criteria.

As noted, the advertiser interface may allow advertisers to locate and bid on specific locations/demographic criteria/events, specific w4 conditions (who, what, when, where) surrounding an annotation, annotator, or user based on combinations of time, place, and social network. Such information may be obtained and provided by the tracking program 208 by mining historical and current w4 data surrounding a map content viewer. A coffee shop advertiser may bid to place ads on a UGC map annotation that shows up on the map location corresponding to a popular nail shop next door to the coffee shop. A tire shop may bid to place ads on virtualized real-estate nearby select gas stations in a particular area.

If a bid wins, the control program 206 will associate the ad corresponding to the bid-winning advertiser onto the virtualized real-estate that was bid on. The advertiser interface according to the bid model may follow the Yahoo! Auctions, eBay, or other auction models. The information associated with the virtualized real-estate, the tracking data, advertiser preferences, user preferences, and other information may be stored in the VRWAS database 140, or in one or more other databases associated with the VRWAS 130 and/or its various components.

The control program 206 may calculate and provide a compensation amount for users in exchange for making the virtualized real-estate available for ad placement. Under the bid model, the compensation amount may be a percentage of the winning bid. Under the registration model, the compensation amount may be determined based on the desirability of the virtualized real-estate. For example, virtualized real-estate corresponding to a larger area of land may be more valuable than that of a smaller area. Virtualized real-estate in a high traffic map area (such as a downtown metropolitan area) may be more valuable than that of a rural area. A user that defines extensive ad-type exclusions may be compensated less than a user that does not define any exclusions. The control system 206 may also define a flat compensation rate per registration. The compensation amount may be provided to the user by printing and mailing a check, a credit to an account, a gift card, or other methods.

The control program 206 may control ad placement. Under the bid model, the control program 206 associates the ad corresponding to the bid-winning advertiser onto the virtualized real-estate that the advertiser bid on. Under the registration model, the control program 206 may include algorithms or other criteria/rules governing what ads are associated with a particular virtualized real-estate. These algorithms take into account any user preferences or advertiser preferences corresponding to the virtualized real-estate or advertisement, respectively.

The control program 206 may also apply a focal point model to advertisement placement. Under the focal point model, the control program 206 may discern customer behavior and focal points on a map interface. Differentiation criteria for focal points include zoom level opacity(e.g., zooming down to street level may bring different sets of ads as opposed to zooming out to state or country level), temporal persistence, specific location as a longitude, and other criteria. The control program 206 may use tracked information as a source of information to determine an optimal match between an advertisement and a virtualized real-estate. The tracked information, which may be obtained by the tracking program 208, may include user interaction with each other, as well as user behavior when configuring map interfaces (such as when users add/create/select tags, keywords, searches on interactive-enabled map interfaces), as well as the w4 information surrounding virtualized real-estate.

For example, a user may be planning and the tracking program 208 has tracked the following search criteria for his/her planning: 5 star hotel+airport+sushi+Broadway show. In this example, the control program 206 may combine the tracked search criteria and map locations the user is looking at to make recommendations (such as in the form of advertisements or links placed on virtualized real-estate) for a location when the user focuses on that location in the map image. If the user is viewing the area of Las Vegas, the control program 206 may place ads on viewable virtualized real-estate (i.e., virtualized real-estate in the area of the map being viewed by the user) that are relevant to the tracked search criteria and the viewed location (i.e., Las Vegas in this example). The control program 206 may also place ads on viewable virtualized real-estate that related to other locations but that match the tracked search criteria. The control program 206 may also place ads on the viewable virtualized real-estate based on the user's profile and current or historical social, temporal and/or spatial conditions. If the user is part of a social network or group planning the vacation together, the tracking program 208 may also track the user profiles, search criteria, and other information associated with the other members of the group, which the control program 206 may also take into account in matching an advertisement with virtualized real-estate. It is understood, therefore, that ads matched by the control program 206 to virtualized real-estate may be changed based on tracked information about the user(s) viewing the map image. In this manner, the control program 206 may increase the likelihood that ads relevant to the user's interest/needs are viewable by the user. Under other conditions, such as according to user/advertiser preferences, some ads may be permanently associated with a particular virtualized real-estate.

The control program 206 may also apply a digital visual insertion model to advertisement placement. According to this model, the control program 206 may place different representations or indicators of ads on a map and/or structural interface. The system may place “signposts”, arrows, or other indicators that indicate, for example, distance/direction information to the location on the map of an advertisers B&M location. In this example, the location of an advertiser's B&M establishment is not on the map rendition a user is currently viewing, the control program 206 may place indicators (e.g., signposts, arrows, etc.) directing the user to a map view that does show the location of the advertiser's B&M establishment. For example, if in the current map rendition that a user is viewing a B&M establishment of an advertiser is nearby but not viewable (such as if the advertiser's B&M establishment is just east of the far right edge of the map rendition being viewed and thus not shown on the screen), the control program 206 may overlay an indicator on the map that tells the viewer that the advertiser's establishment is east 0.4 miles.

In a street-level first-person image, the control program 206 may place arrows along the rendition of the street that the user may click on or otherwise follow that lead to a street-level first-person image of the advertiser's B&M location. The advertiser interface may be configured to allow an advertiser to purchase or bid on such a feature (i.e., to have direction/distance indicators placed on virtualized real-estate or on white spaces in the street-level first-person or map image).

The control program 206 may also apply a computer-vision-based algorithm for a map whitespace identification model. Map images often use color to identify geographic features of the map. Salient features are typically drawn in bright colors against a neutral background. Let B be the set of neutral background colors used on the map. The control program 206 may identify non-meaningful whitespace in the map-tile image by matching the color-value of each pixel of the map-tile image against the set of defined background colors B. If the color of a particular pixel is a neutral background color, then that pixel may be added to the available whitespace for the map-tile. The control program 206 may aggregate adjacent whitespace pixels (from within and across map-tile images) into whitespace regions. If the total area of a whitespace region is greater than an adjustable whitespace threshold, then the whitespace region may be made available for auction by advertisers.

The controls system 206 may also be configured to identifying semantically-meaningful whitespace in maps and automatically associate semantically-relevant ads with the whitespace as part of the ad placement. Maps include airports, shopping centers, parks, nature reserves, and other identifiable entities and locals. These places often carry associated uses and semantic associations, such as travel, recreation, children, shopping, etc., which may be used to annotate the surrounding whitespace, or augment the identification of whitespace. For example, in a map area around an airport, the control program 206 may associate advertisements for travel services, hotels, flights, etc., with the in-map whitespace. In a map area around a park which contains a children's playground, the control program 206 may associate advertisements for toys, or children's clothing, or family-services with the surrounding whitespace.

The control program 206 may also define contextually-irrelevant whitespace by matching a user's search intent with the semantic association of a space. For example, if a user is searching for shopping in a map, the control program 206 may use a near-by park as whitespace as the associated usages for a park do not intersect the shopping focus of the user's current query.

The control program 206 may overlay advertise-able whitespace in first-person perspective geographic views. First-person perspective geographic views provide photographic or photorealistic virtual representations of an environment from a given vantage point. There are generally two identifiable whitespace regions in these first-person perspective views: around-view-port, and in-view-port. The around-view-port whitespace is defined as the space surrounding the view-port (i.e., padding and margins surrounding the image which separates it from other elements of the interface). The in-view-port whitespace is digitally layered into the view-port, and can be created, for example, through the insertion of whitespace elements, (e.g., virtual sign posts or billboards), or reclaimed from blank space in the view-port (e.g., road surfaces, walls, empty sky, etc).

For example, a retail store has purchased, through the advertiser interface, advertising within a thirty-mile radius of their San Jose, Calif. store. A user is viewing, in a north orientation, a first-person perspective map of a location five miles east of the retail store. Around-view-port whitespace on the left (western pointing direction) of the view-port could be used to place an advertisement for the retail store's location just five miles in that direction. In-view-port whitespace may indicate via overlaid, virtual signage that the retail store is five miles west of the user's current viewing location (such as with an arrow pointing in that direction). Clicking on the linked ads could provide the user with turn-by-turn directions from their current location to the store.

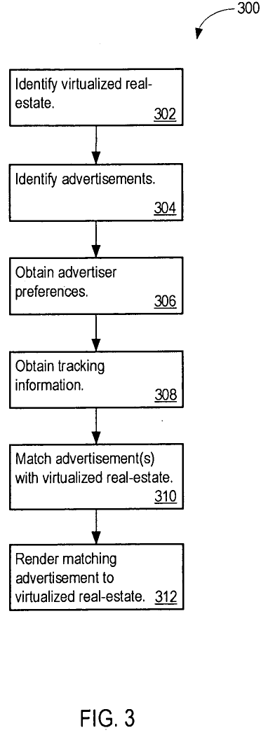

FIG. 3 shows an exemplary process 300 that may be used to associate advertisements with virtualized real-estate. The process 300 identifies virtualized real-estate on a map image available for ad placement (Act 302). The virtualized real-estate may be identified by obtaining a virtualized real-estate registration from a user. The process 300 may obtain registration information from a user that wishes to register virtualized real-estate for ad placement. The registration information may include an identification of the virtualized real-estate, user preferences, and/or information about the virtualized real-estate and user. The identification of the virtualized real-estate may be a postal address, longitude/latitude coordinates, or other information that would allow the process to locate the virtualized real-estate on, for example, an on-line map.

The user preferences obtained by the process 300 may include how, what, and where an advertisement is placed on or otherwise associated with the virtualized real-estate. The user preferences may include, for example, an ad-type exclusion that indicates a certain type of advertising content that the user does not wish to be associated with the user's virtualized real-estate. The user preferences may also include an indication by the user as to whether the user would like the process 300 to automatically associate, in consideration of any other user preferences, advertisements with the virtualized real-estate, or whether the user would like to place the virtualized real-estate up for bid. The process 300 may obtain the identification of the virtualized real-estate and corresponding user preferences by providing an interface though which the user may identify the virtualized real-estate and define any user preferences.

Identifying the virtualized real-estate may also be obtained through whitespace identification, where map whitespace is the virtualized real-estate. The process 300 may identify whitespace in a map image by matching the color-value of each pixel of the map image against a set of defined background colors. If the color of a particular pixel is a neutral background color, then the process 300 may add that pixel to a set of available whitespace for ad placement. The process 300 may aggregate adjacent whitespace pixels (from within and across map images) into whitespace regions. If the total area of a whitespace region is greater than an adjustable whitespace threshold, then the whitespace region may be made available for auction by advertisers, or for automatic ad placement by the process 300.

The process 300 identifies advertisements to be placed on the virtualized real-estate (Act 304). The identification of advertisements may be obtained from one or more advertisers. The process 300 may, for example, provide an advertiser interface through which the advertiser may identify and/or submit the advertisement to be placed.

The process 300 obtains advertiser preferences associated with the advertisements (Act 306). The process 300 may obtain the advertiser preferences from the advertiser through the advertiser interface. The advertiser preferences may include preferences related to where, what, or how their advertisement is placed on or otherwise associated with virtualized real-estate. The advertiser preferences may include an indication of whether the advertiser wishes to directly bid or purchase the ad space on virtualized real-estate, or whether the advertiser wishes the process 300 to automatically place the advertisement on relevant real-estate determined by the advertiser preferences.

The process obtains tracking information associated with the virtualized real-estate (Act 308). The tracking information may be w4 tracking information (who, what, when, where) associated with the virtualized real-estate and/or the map area associated with the virtualized real-estate's location. The w4 tracking information may include the types of viewers that view the map area (and how often they view it) that includes the virtualized real-estate's location, what on the map those viewers are viewing in particular, and under what conditions. Specific w4 tracking information may be, for example, the resolution at which the map area surrounding the virtualized real-estate is generally viewed (e.g., at a street level versus a state level), the focus of the viewer when viewing the map area determined, for example, by tracking the pointer location, the type of device the map area is being viewed from (e.g., desktop versus mobile device), the location from which the map area is generally viewed (e.g., from homes, business, internet cafes, etc.), keywords/tags that are used in searches including on interactive search-enabled maps, as well as other information related to the who, what, when, and where corresponding to user traffic related to the virtualized real-estate.

The tracking information allows the process 300 to match a virtualized real-estate with contextually relevant advertisements. In doing so, likely viewers are benefited by receiving advertisements that are more likely to be in line with their interests/needs. In provided more contextually relevant advertisements for viewers, click traffic on advertisements is increased, thus benefiting advertisers as well.

The process 300 matches the virtualized real-estate with at least one of the advertisements based on the advertiser preferences and/or the tracking information (Act 310). If an advertiser had chosen to directly bid on or purchase the ad space on virtualized real-estate, the process 300 may match the virtualized real-estate with an advertisement by providing an interface, such as an auction-type interface, allowing the advertiser to bid on identified virtualized real-estate. The process 300 may also allow advertisers to search the available virtualized real-estate according to the advertiser preferences and/or according to tracking information associated with the virtualized real-estate. The process 300 may also automatically search for and display to the advertiser the virtualized real-estate that matches the advertiser preferences.

The process 300 may match the virtualized real-estate with an advertisement by determining a match between the virtualized real-estate and one or more of the advertisements. A match may be determined based on the user preferences, advertiser preferences, and/or tracking information. For example, the process 300 may take into account a user's ad-type exclusions, advertiser preferences defining the advertiser's preferred characteristics of the virtualized real-estate on which the ad will be displayed, and tracking information to match the virtualized real-estate with relevant advertising.

Matching may also include identifying semantically meaningful whitespace in maps. The process 300 may place the identified semantically meaningful whitespace up for auction by advertisers, or may automatically associate the semantically-relevant ads with the identified whitespace. Maps include airports, shopping centers, parks, nature reserves, and other identifiable entities and locals. These places often carry associated uses and semantic associations, such as travel, recreation, children, shopping, etc., which may be used to annotate the surrounding whitespace, or augment the identification of whitespace. For example, in a map area around an airport, the process 300 may associate advertisements for travel services, hotels, flights, etc., with the in-map whitespace. In a map area around a park which contains a children's playground, the process 300 may associate advertisements for toys, or children's clothing, or family-services with the surrounding whitespace.

The process 300 applies the matching advertisement to the virtualized real-estate on a map image (Act 312). The process 300 may overlay the matching advertisement on or next to the virtualized real-estate in the map image.

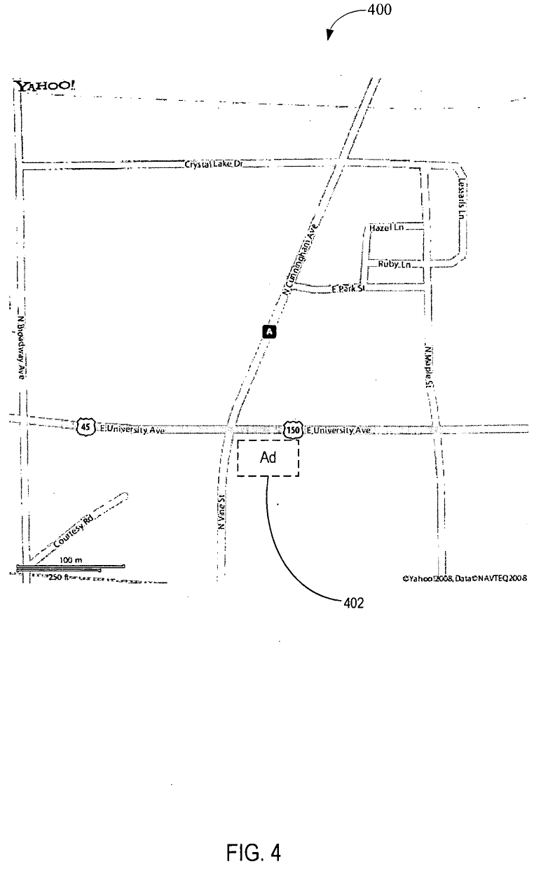

FIG. 4 shows a map image rendition 400 including an advertisement 402 overlaid on virtualized real-estate. The placement of the advertisement on the virtualized real-estate may be according to the user and/or advertiser preferences. For example, the advertiser preferences may indicate that its ad be placed only at certain map resolutions, or only when the map is being viewed from a certain location or type of device.

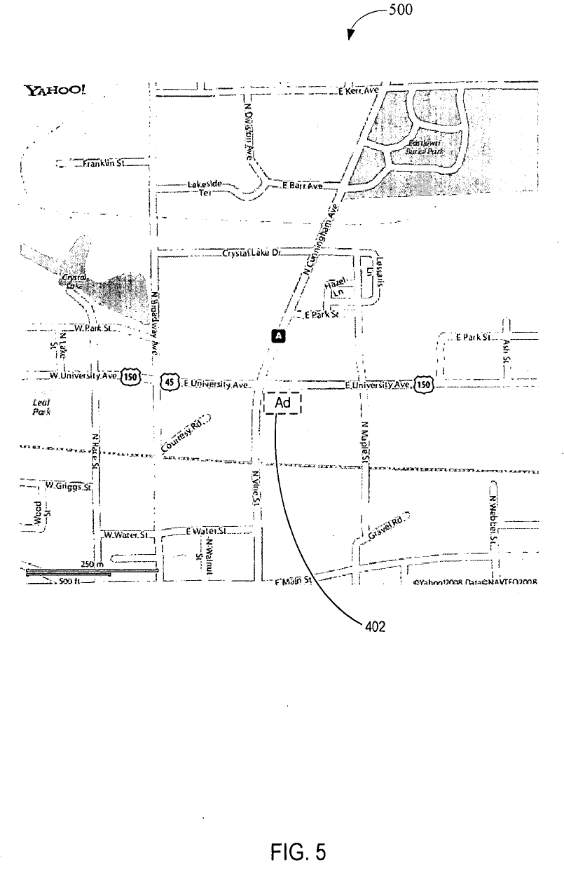

FIG. 5 shows a zoomed-out rendition 500 of the map location shown in FIG. 4. As a viewer changes the map resolution (i.e., zooming in or zooming out), the process 300 may rescale the advertisement to match the new resolution. In FIG. 5, for example, the advertisement 402 is smaller than in FIG. 4 to match the zoomed-out resolution of the rendition 500 relative to the rendition 400.

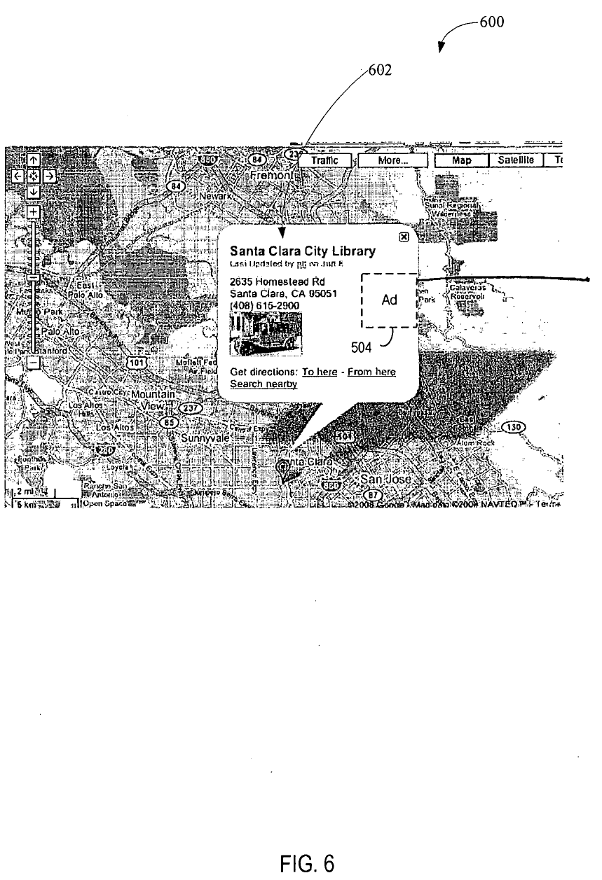

FIG. 6 shows a map image rendition 600 including a UGC annotation 602. The process 300 may overlay an advertisement 604 matched with the virtualized real-estate (i.e., the UGC annotation 602) onto the virtualized real-estate.

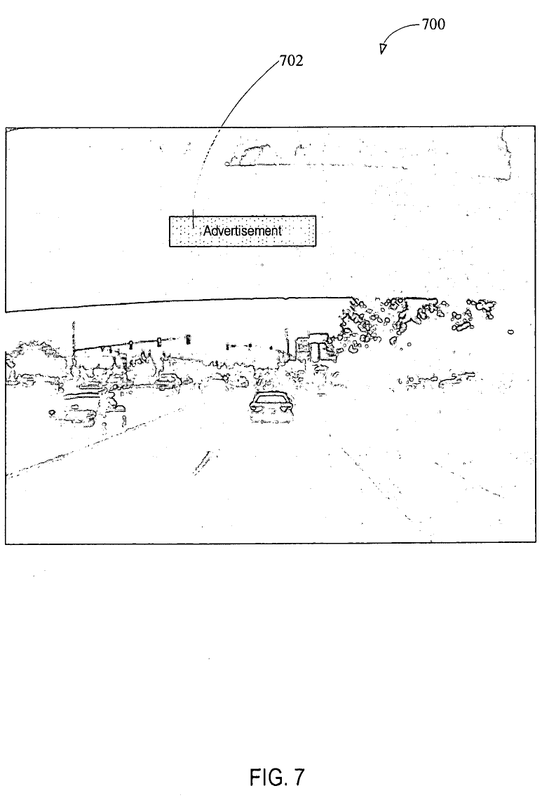

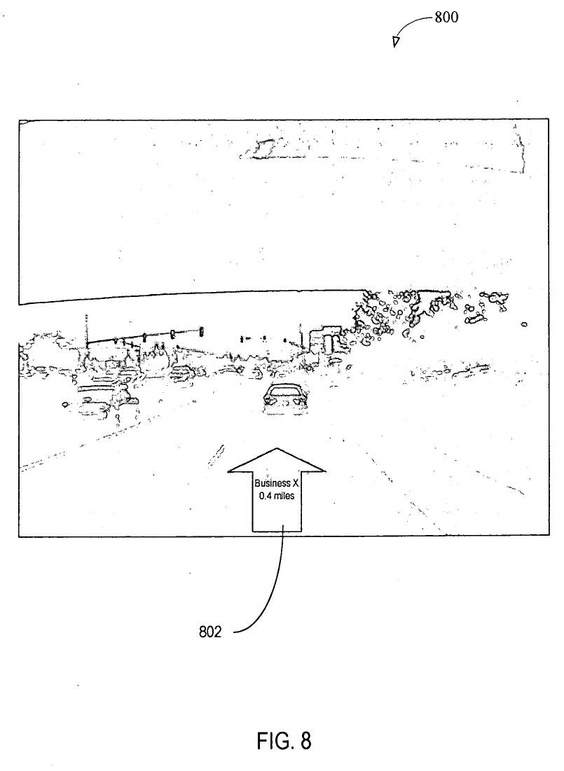

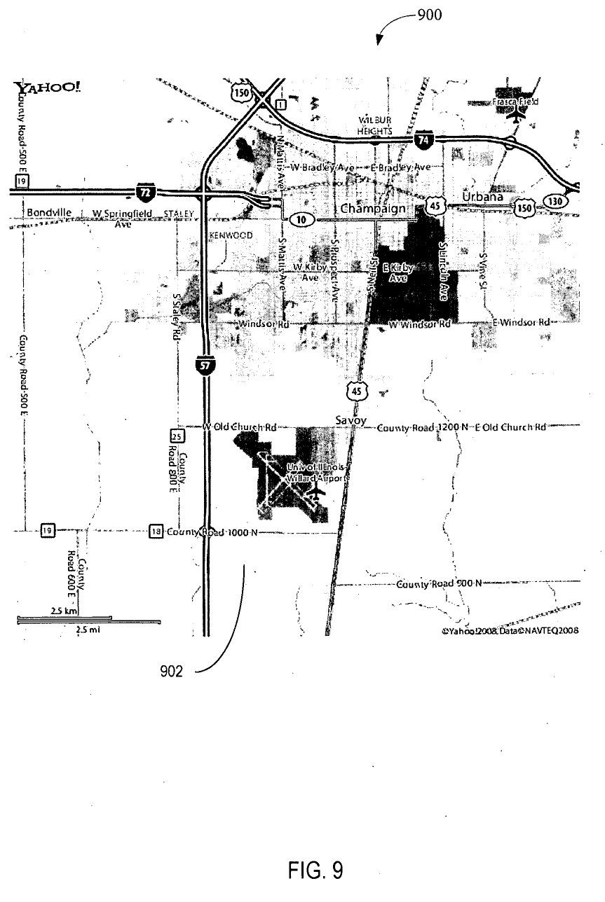

FIG. 7 shows a street-level first-person image 700 including an advertisement 702 overlaid on a structure 704 shown in the image. FIG. 8 shows a street-level first person image 800 including a directional/distance identifier 802 overlaid on the image 800. The process 300 may allow advertisers to bid on or purchase the feature of placing direction/distance identifiers on map images that indicate to a viewer, for example, the location of a B&M location of the advertiser's business or affiliates. FIG. 9 shows a map image rendition 900 showing identified whitespace regions 902 surrounding an airport region 904.

User preferences may also define how/where an ad is applied to the virtualized real-estate. The process 300 applies the matching advertisement to the virtualized real-estate according to any user/advertiser preferences. In the absence of any such preferences, the process 300 may apply a default setting to ad placement, such as by overlaying the advertisement over the virtualized real-estate. If the virtualized real-estate is a UGC annotation or other user-generated content, the user preferences may define where on the UGC the ad will be placed. The process 300 may also define a default location on the UGC on which an advertisement is placed. If the virtualized-real estate is an object or structure in a street-view first-person image, the user preferences may defined where on the structure the advertisement and/or identifier is placed. The user preferences may also indicate a preference that multiple advertisements be placed on a particular structure or object.

If the virtualized real-estate is whitespace, the process 300 may overlay advertise-able whitespace in first-person perspective geographic views. First-person perspective geographic views provide photographic or photorealistic virtual representations of an environment from a given vantage point. There are generally two identifiable whitespace regions in these first-person perspective views: around-view-port, and in-view-port. The around-view-port whitespace is defined as the space surrounding the view-port (i.e., padding and margins surrounding the image which separates it from other elements of the interface). The in-view-port whitespace is digitally layered into the view-port, and can be created, for example, through the insertion of whitespace elements, (e.g., virtual sign posts or billboards), or reclaimed from blank space in the view-port (e.g., road surfaces, walls, empty sky, etc).

For example, a retail store has purchased, through the advertiser interface, advertising within a thirty-mile radius of their San Jose, Calif. store. A user is viewing, in a north orientation, a first-person perspective map of a location five miles east of the retail store. Around-view-port whitespace on the left (western pointing direction) of the view-port could be used to place an advertisement for the retail store's location just five miles in that direction. In-view-port whitespace may indicate via overlaid, virtual signage that the retail store is five miles west of the user's current viewing location (such as with an arrow pointing in that direction). Clicking on the linked ads could provide the user with turn-by-turn directions from their current location to the store.

From the foregoing, it can be seen that the virtualized real world processing system discussed herein provides contextually and/or geographically relevant advertising content to users of on-line map images. In particular, the virtualized real world advertising system takes advantage of largely untapped advertising space. Further, the system affords advertisers and users alike a level of autonomy in how, where, and what advertisements are associated with the available advertising space, as well as obtains and provides tracking information that allows advertisements to be optimally matched with virtualized real-estate in order to provide viewers of a map image with content that is more relevant to the viewers likely interests and needs.

While various embodiments of the invention have been described, it will be apparent to those of ordinary skill in the art that many more embodiments and implementations may be possible within the scope of the invention. Accordingly, the invention is not to be restricted except in light of the attached claims and their equivalents.

1. A method for applying on-line advertisements to virtualized real-estate content, comprising:
identifying a virtualized real-estate on a map image for advertisement placement;
obtaining advertiser preferences associated with advertisements in a set of advertisements;
obtaining tracking information associated with the virtualized real-estate;
identifying, based on the advertiser preferences and the tracking information, a matching advertisement from among the set of advertisements to match with the virtualized real-estate; and
rendering the matching advertisement to the virtualized real-estate on the map image.

2. The method of claim 1, where identifying a virtualized real-estate comprises obtaining user preferences.

3. The method of claim 2, where identifying the matching advertisement is based further on the user preferences.

4. The method of claim 1, further comprising:
making the virtualized real-estate available for bid by a first advertiser associated with an advertisement in the set of advertisements; and
identifying a winning bid by the first advertiser, where the matching advertisement is the advertisement associated with the first advertiser.

5. The method of claim 1, where the tracking information includes w4 tracking information associated with the virtualized real-estate.

6. The method of claim 1, where the virtualized real-estate comprises a user-generated map annotation and rendering the matching advertisement comprises overlaying the matching advertisement on the user-generated map annotation.

7. The method of claim 1, where the virtualized real-estate comprises an object viewable in a street-view first-person image, and where rendering the matching advertisement comprises overlaying the matching advertisement on the object.

8. The method of claim 1, where identifying the virtualized real-estate comprises identifying a whitespace region on the map image, and where the matching advertisement is identified as an advertisement whose content is identified as relevant to a region on the map image adjacent to the identified whitespace region.

9. A virtualized real world advertising system, comprising:
a processor;
a memory coupled to the processor, the memory comprising:
instructions that, when executed by the processor, cause the processor to:
identify a virtualized real-estate on a map image for advertisement placement;
obtain advertiser preferences associated with advertisements in a set of advertisements;
obtain tracking information associated with the virtualized real-estate;
identify, based on the advertiser preferences and the tracking information, a matching advertisement from among the set of advertisements to match with the virtualized real-estate; and
render the matching advertisement to the virtualized real-estate on the map image.

10. The system of claim 9, where the instructions that, when executed by the processor, cause the processor to identify a virtualized real-estate further cause the processor to obtaining user preferences.

11. The system of claim 10, where the instructions that, when executed by the processor, cause the processor to identify a matching advertisement comprise instructions that cause the processor to identify the matching advertisement based further on the user preferences.

12. The system of claim 9, further comprising instructions that, when executed by the processor, cause the processor to:
make the virtualized real-estate available for bid by a first advertiser associated with an advertisement in the set of advertisements; and
identify a winning bid by the first advertiser, where the matching advertisement is the advertisement associated with the first advertiser.

13. The system of claim 9, where the tracking information includes w4 tracking information associated with the virtualized real-estate.

14. The system of claim 9, where the virtualized real-estate comprises a user-generated map annotation and the instructions that, when executed by the processor, cause the processor to render the matching advertisement comprise instructions that cause the processor to overlay the matching advertisement on the user-generated map annotation.

15. The system of claim 9, where the virtualized real-estate comprises an object viewable in a street-view first-person image, and where the instructions that, when executed by the processor, cause the processor to render the matching advertisement comprise instructions that cause the processor to overlaying the matching advertisement on the object.

16. The system of claim 9, where the instructions that, when executed by the processor, cause the processor to identify the virtualized real-estate comprise instructions that cause the processor to identify a whitespace region on the map image and where the matching advertisement is identified as an advertisement whose content is identified as relevant to a region on the map image adjacent to the identified whitespace region.

17. A product comprising:
a computer readable medium; and
instructions stored on the medium that, when executed, cause a processor in a virtualized real world processing system to:
identify a virtualized real-estate on a map image for advertisement placement;
obtain advertiser preferences associated with advertisements in a set of advertisements;
obtain tracking information associated with the virtualized real-estate;
identify, based on the advertiser preferences and the tracking information, a matching advertisement from among the set of advertisements to match with the virtualized real-estate; and
render the matching advertisement to the virtualized real-estate on the map image.

18. The product of claim 17, where the instructions that, when executed, cause the processor to identify a virtualized real-estate further cause the processor to obtaining user preferences.

19. The product of claim 18, where the instructions that, when executed, cause the processor to identify a matching advertisement comprise instructions that cause the processor to identify the matching advertisement based further on the user preferences.

20. The product of claim 17, further comprising instructions that, when executed, cause the processor to:
make the virtualized real-estate available for bid by a first advertiser associated with an advertisement in the set of advertisements; and
identify a winning bid by the first advertiser, where the matching advertisement is the advertisement associated with the first advertiser.

21. The product of claim 17, where the tracking information includes w4 tracking information associated with the virtualized real-estate.

22. The product of claim 17, where the virtualized real-estate comprises a user-generated map annotation and the instructions that, when executed, cause the processor to render the matching advertisement comprise instructions that cause the processor to overlay the matching advertisement on the user-generated map annotation.

23. The product of claim 17, where the virtualized real-estate comprises an object viewable in a street-view first-person image, and where the instructions that, when executed, cause the processor to render the matching advertisement comprise instructions that cause the processor to overlaying the matching advertisement on the object.

24. The product of claim 17, where the instructions that, when executed, cause the processor to identify the virtualized real-estate comprise instructions that cause the processor to identifying a whitespace region on the map image and where the matching advertisement is identified as an advertisement whose content is identified as relevant to a region on the map image adjacent to the identified whitespace region.
